(19) United States
(12) Patent Application Publication
(10) Pub. No.: US 2026/0213224 A1
(43) Pub. Date: Jul. 23, 2026

(54) FUEL CELL CATALYST AND PREPARATION METHOD THEREFOR

(71) Applicant: KOLON INUSTRIES, INC., Seoul (KR)

(72) Inventors: Jung Ho KIM, Seoul (KR); Jun Young KIM, Seoul (KR); Kah Young SONG, Seoul (KR); Nak Won KONG, Seoul (KR); Eun Su LEE, Seoul (KR); Hyeong Su KIM, Seoul (KR); Kyoung Sik NAM, Seoul (KR); Chan Mi PARK, Seoul (KR); Ju Sung LEE, Seoul (KR)

(21) Appl. No.: 19/139,613

(22) PCT Filed: Mar. 24, 2023
(86) PCT No.: PCT/KR2023/003932

§ 371 Date: Jun. 16, 2025

(30) Foreign Application Priority Data
Mar. 29, 2022 (KR) 10-2022-0039223

(51) Int. Cl. H01M 4/88; H01M 4/90

(52) U.S. Cl. CPC H01M 4/885; H01M 4/9041; H01M 4/9075

(57) ABSTRACT

The present invention relates to a fuel cell catalyst preparation method and a fuel cell catalyst, the method comprising the steps of: (a) permeating a metal catalyst precursor or a metal catalyst seed into pores in a porous support; (b) producing metal catalyst particles by reducing the metal catalyst precursor or the metal catalyst seed; (c) removing metal catalyst particles which are outside of the pores of the support or which exhibit a weak binding force; and (d) by reducing and growing the metal catalyst particles by adding an additional metal catalyst precursor and a reducing agent, obtaining post-growth metal catalyst particles which are more stably supported.

### TECHNICAL FIELD

The present disclosure relates to a preparation method for a fuel cell catalyst having excellent durability and improved performance, and to a catalyst prepared thereby.

### BACKGROUND ART

Fuel cells are cells that directly convert chemical energy generated by oxidation of fuel into electrical energy. Fuel cells are widely considered a next-generation energy source due to their environmentally friendly features such as high energy efficiency and low pollutant emissions.

Generally, a fuel cell has a structure in which an electrolyte membrane is interposed between an oxidation electrode (anode) and a reduction electrode (cathode). This structure is referred to as a membrane electrode assembly (MEA).

Fuel cells can be classified into alkaline electrolyte fuel cells and polymer electrolyte membrane fuel cells (PEMFC) depending on the type of electrolyte membrane. Of these, polymer electrolyte fuel cells are gaining much attention as power supply devices for portable, automobile, and household applications due to their advantages such as low operating temperature of less than 100° C., fast starting and responding characteristics, and excellent durability.

A representative example of such polymer electrolyte membrane fuel cells is a proton exchange membrane fuel cell (PEMFC), which uses hydrogen gas as fuel.

In briefly describing the reaction that occurs in a polymer electrolyte membrane fuel cell, first, when fuel such as hydrogen gas is supplied to an anode, hydrogen at the anode is oxidized to produce protons (H⁺) and electrons (e⁻). The protons (H⁺) thus produced are transferred to a cathode through a polymer electrolyte membrane, whereas the electrons (e⁻) thus produced are transferred to the cathode through an external circuit. Oxygen is supplied to the cathode, and oxygen is reduced by combining with protons (H⁺) and electrons (e⁻) to produce water.

Platinum or other precious metals with high catalytic activity and high corrosion resistance are used as metal catalysts for forming electrodes of a membrane electrode assembly (MEA).

Such platinum and other precious metals commonly used as catalysts for fuel cells are expensive, which increases the manufacturing cost of fuel cells. Therefore, research is ongoing into technologies that can lower the manufacturing cost of fuel cells by reducing the amount of metal catalysts used while maintaining cell performance.

In an effort to increase the active surface area of catalysts and reduce the amount of catalysts used, there has been developed a catalyst formed by dispersing metal catalyst particles on the surface of an electrically conductive carrier (support) (e.g., carbon, metal oxide, C₃N₄, etc.).

However, these conventional catalysts have the following drawback. When the fuel cell operates for a long-period of time, the metal catalyst may undergo migration and/or oxidation due to the high voltage and highly acidic environment, which accelerates degradation of the catalyst. For this reason, prevention of catalyst degradation due to long-term operation of the fuel cell is crucial for improving the durability and lifespan of the fuel cell.

Therefore, in order to realize improved performance and lifespan of the fuel cell, research is actively exploring a fuel cell catalyst with excellent durability and performance.

### DISCLOSURE

### Technical Problem

An objective of the present disclosure is to provide a fuel cell catalyst having excellent durability and performance, a preparation method therefor, and a fuel cell including the catalyst.

### Technical Solution

In order to accomplish enhanced durability of a fuel cell catalyst, the inventors of the present disclosure have provided a fuel cell catalyst with excellent performance and durability by preparing metal catalyst particles inside pores of a carrier, removing metal catalyst particles supported outside the carrier and those with weak binding force, and further growing the metal catalyst particles. Additionally, provided is a fuel cell catalyst that includes metal catalyst particles located inside pores of a carrier and exhibiting stable performance through post-growth. According to the present disclosure, provided is a fuel cell including a catalyst with improved durability and performance compared to conventional fuel cell catalysts.

According to an aspect of the present disclosure, there is provided a fuel cell catalyst, including: a porous carrier; and a metal catalyst supported on the porous carrier, in which the metal catalyst may be supported in pores of the porous carrier in an amount of equal to or greater than 74% with respect to the total number of metal catalyst particles supported on the porous carrier.

The metal catalyst may be supported in the pores of the porous carrier in an amount of equal to or greater than 80% with respect to the total number of the metal catalyst particles supported on the porous carrier.

Each of the metal catalyst particles supported in the pores of the porous carrier may have a size of −15% to +15% with respect to a pore size of the porous carrier.

Each of the metal catalyst particles supported in the pores of the porous carrier may have a size of −5% to +5% with respect to the pore size of the porous carrier.

The metal catalyst may be supported in the pores of the porous carrier by filling equal to or greater than 60% of the pores with respect to the total pore volume.

The fuel cell catalyst may have a specific surface area of equal to or less than 300 m²/g.

The porous carrier may have a pore size of 2 to 15 nm.

The metal catalyst may have a diameter of 3 to 14 nm.

The metal catalyst inside the pores of the porous carrier may have a diameter that is at least 1 nm smaller than that of the metal catalyst outside the pores.

According to another aspect of the present disclosure, there is provided a preparation method for a fuel cell catalyst, the preparation method including the steps of: (a) infiltrating a metal catalyst precursor or a metal catalyst seed into pores in a porous carrier; (b) producing metal catalyst particles by reducing the metal catalyst precursor or the metal catalyst seed; (c) removing metal catalyst particles present outside the pores of the porous carrier or metal catalyst particles bound with weak binding force inside the pores of the porous carrier; and (d) reducing and growing the metal catalyst particles by adding an additional metal catalyst precursor and a reducing agent, thereby obtaining a metal catalyst.

The step (a) may be performed by vacuum infiltration.

The vacuum infiltration may be performed for 5 to 30 minutes under conditions of pressure of 0.01 to 90 kPa.

The metal catalyst precursor or the metal catalyst seed of the step (a) may include a metal selected from the group consisting of platinum and a platinum-based alloy.

The preparation method may further include the step of: (aa) preparing a metal catalyst seed by partially reducing or hydrating a metal catalyst precursor prior to the step (a).

The step (aa) may be performed by mixing and heating the metal catalyst precursor and at least one additive selected from the group consisting of formaldehyde, formic acid, citric acid, ascorbic acid, urea, and hexamethylenetetramine.

The step (b) may be performed by adding at least one additive selected from the group consisting of NaBH₄, hydrazine, e-beam, LiAlH₄, diborane, ethylenediamine, formaldehyde, formic acid, citric acid, ascorbic acid, urea, glycols such as ethylene glycol, polyols having three or more-OH groups, and hexamethylenetetramine to the metal catalyst precursor or the metal catalyst seed, followed by stirring or heating.

The step (c) may be performed by ultrasonication or centrifugation.

The ultrasonication may be performed by applying ultrasonic waves for 5 to 80 minutes at an intensity of equal to or greater than 20 kHz and an amplitude of 30% to 90%.

The centrifugation may be performed at 13,000 to 35,000 rpm for 10 to 100 minutes.

The additional metal catalyst precursor of the step (d) may include a metal the same as or different from a metal contained in the metal catalyst seed of the step (a), and the metal may be selected from the group consisting of platinum and a platinum-based alloy.

The additional metal catalyst precursor of the step (d) may be added in an amount of 10 to 40 wt % with respect to a weight of the metal catalyst particles supported on the carrier.

The reducing agent of the step (d) may be at least one selected from the group consisting of formaldehyde, formic acid, citric acid, ascorbic acid, hexamethylenetetramine, ethylene glycol, tetraethylene glycol, and urea.

The reducing agent of the step (d) may be added t an equivalent ratio of 10 to 100 per mole of the additional metal catalyst precursor.

A surfactant, an organic acid, or both of them may be additionally added in the step (d).

The surfactant may be at least one surfactant selected from the group consisting of (C10-C18 alkyl) trimethylammonium salt-based cationic surfactants, (C10-C18 alkyl) sulfite salt-based anionic surfactants, and (C10-C18 alkyl) poly(ethylene oxide)-based nonionic surfactants.

The organic acid may be at least one organic acid selected from carboxylic acids.

The step (d) may be performed at a temperature of 80° C. to 150° C. for 30 to 100 minutes.

According to still another aspect of the present disclosure, there is provided a membrane electrode assembly, including the above-described fuel cell catalyst.

According to still another aspect of the present disclosure, there is provided a fuel cell, including the above-described membrane electrode assembly.

### Advantageous Effects

A fuel cell catalyst according to the present disclosure has the effect of improving durability and performance by infiltrating a metal catalyst precursor or a metal catalyst seed into pores through a physical method such as vacuum infiltration and then adding an additional catalyst precursor to reduce and grow the catalyst.

The fuel cell catalyst according to the present disclosure has the effect of reducing the manufacturing cost of a fuel cell including the catalyst due to its improved performance and durability.

### DESCRIPTION OF DRAWINGS

FIG. 1 is a sectional view schematically illustrating a membrane electrode assembly according to the present disclosure.

FIG. 2 is a schematic view illustrating the overall configuration of a fuel cell according to an embodiment of the present disclosure.

FIG. 3 is a view illustrating TEM images of a fuel cell catalyst according to Example 1 of the present disclosure.

FIG. 4 is a TEM image of a fuel cell catalyst according to Example 2 of the present disclosure.

FIG. 5 is a TEM image of a fuel cell catalyst according to Example 3 of the present disclosure.

FIG. 6 is a graph illustrating the results of XRD analysis for fuel cell catalysts according to Comparative Example and Examples of the present disclosure.

FIG. 7 is a graph illustrating the results of BET analysis for a carrier utilized in the present disclosure and the fuel cell catalysts according to Comparative Example and Examples.

### BEST MODE

Hereinbelow, each configuration of the present disclosure will be described in detail such that the present disclosure can be easily embodied by one of ordinary skill in the art to which this disclosure belongs, but this is merely one example, and the scope of the present disclosure is not limited thereto.

The term “preferred” or “preferably” as used in the present disclosure indicates embodiments of the present disclosure that provide specific advantages under specific conditions. However, other embodiments can also be preferred under the same conditions or under different conditions. Furthermore, it should be noted that description of one or more preferred embodiments is not intended to prove that other embodiments are not useful or to exclude other embodiments within the scope of the present disclosure.

The term “comprising” as used in this specification is used to list materials, compositions, devices, and methods which are useful for the present disclosure and is not intended to limit the scope of the present disclosure to the listed examples.

The terms “pore size” and “particle size of metal catalyst” as used in this specification, unless otherwise defined, refer to the most frequent pore size and the most frequent particle size of metal catalyst, respectively.

According to an aspect of the present disclosure, there is provided a fuel cell catalyst, including a porous carrier (support) and a metal catalyst supported (embedded) on the porous carrier, in which the amount of the metal catalyst supported inside pores of the porous carrier is greater than the amount thereof located outside the porous carrier. Specifically, the metal catalyst may be supported in the pores of the porous carrier in an amount of equal to or greater than 74%, specifically equal to or greater than 80%, with respect to the total number of metal catalyst particles supported on the porous carrier. In the catalyst according to the present disclosure, by setting the amount of the metal catalyst supported in the pores of the porous carrier within the above range, excellent catalytic performance and improved durability are ensured. Such a large supported amount in the pores is believed due to the fact that in a preparation method which will be described later, the pores are filled with the metal catalyst particles through a physical infiltration method such as vacuum adsorption into the carrier pores (step (a) of the preparation method according to the present disclosure) and subsequent additional growth of the metal catalyst particles in the pores (step (d) of the preparation method according to the present disclosure). The metal catalyst according to the present disclosure may be supported in the pores of the porous carrier by filling equal to or greater than 60%, specifically equal to or greater than 65% of the pores, with respect to the total pore volume. Additionally, for the same reason, the surface area of the porous carrier after post-growth of the metal catalyst particles may be reduced by equal to or greater than 60%, specifically, equal to or greater than 65%, compared to the surface area of an untreated porous carrier.

In the present disclosure, the porous carrier may be any carrier that can be used as a carrier in the field of fuel cell catalyst technology, and may be, for example, a carbon-based carrier, a porous inorganic oxide carrier such as zirconia, alumina, titania, silica, and ceria, or a zeolite carrier.

Specifically, a carbon-based carrier with excellent electrical conductivity may be used as the porous carrier. For example, the carbon-based carrier may be selected from the group consisting of graphite, super P, carbon fiber, carbon sheet, carbon black, Ketjen Black, Denka black, acetylene black, carbon nanotube (CNT), carbon sphere, carbon ribbon, fullerene, activated carbon, carbon nanofiber, carbon nanowire, carbon nanoball, carbon nanohorn, carbon nanocage, carbon nanoring, ordered nano-/meso-porous carbon, carbon aerogel, mesoporous carbon, graphene, stabilized carbon, activated carbon, and a combination of two or more thereof.

The porous carrier may have a specific surface area of equal to or less than 300 m²/g and equal to or greater than 200 m²/g. The porous carrier may have a size (diameter) of 20 to 900 nm (nanometers). Additionally, the carrier may have a pore size of 2 to 15 nm (nanometers), for example, 3 to 13 nm or 4 to 11 nm. When the pores are smaller or larger than the above size, the metal catalyst particles may not be sufficiently supported and grown inside the pores.

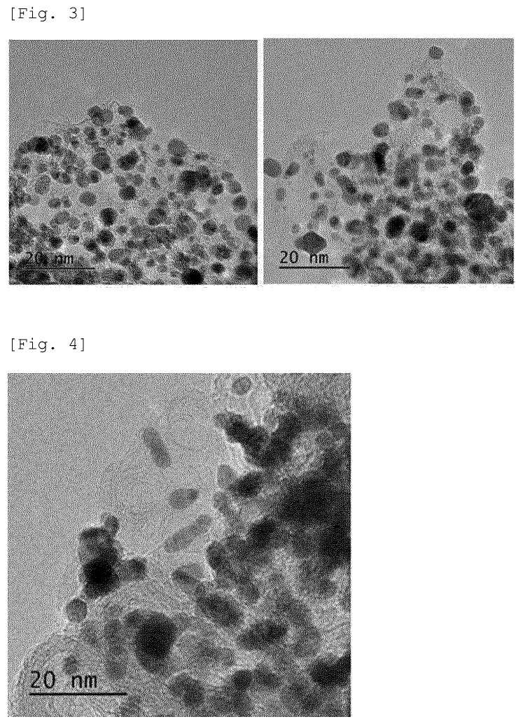

The supported metal catalyst is a metal catalyst reduced and grown in the pores of the carrier according to the preparation method which will be described later. The shape of the catalyst after growth may be spherical, oval, rod-shaped, dendrite-shaped, or a combination thereof. As can be seen in FIGS. 3 and 4, the shape of the catalyst is generally spherical and oval and a crystalline shape is partially present, and in some cases, a rod shape is also partially present.

In the supported catalyst, a supported amount of the metal catalyst may be 10 to 80 parts by weight, specifically 20 to 65 parts by weight, per 100 parts by weight of the porous carrier. By setting the supported amount within the above range, the durability of the catalyst is improved without deterioration in performance.

Each of the metal catalyst particles after post-growth supported in the pores of the porous carrier may have a size of −15% to +15%, specifically, −5% to +5%, with respect to the pore size of the porous carrier. For example, the metal catalyst after growth may have an average diameter of 3 to 14 nm, specifically 5 to 12 nm.

Additionally, the metal catalyst inside the pores of the porous carrier may have a diameter that is at least 1 nm smaller than that of the metal catalyst outside the pores. By growing the metal catalyst according to the present disclosure from within the pores of the porous carrier to have the above size range, excellent catalytic performance and improved durability are ensured.

The metal catalyst may include a metal selected from the group consisting of platinum and a platinum-based alloy. Specifically, the platinum and the platinum-based alloy may be selected from the group consisting of Pt, Pt—Ru, Pt—Ir, Pt—Pd, Pt—Mn, Pt—Sn, Pt—Mo, Pt—Cr, Pt—W, Pt—Ni, Pt—Co, Pt—Y, Pt—Ru—W, Pt—Ru—Ir, Pt—Ru—Ni, Pt—Ru—Mo, Pt—Ru—Rh—Ni, Pt—Ru—Sn—W, Pt—Ru—Ir—Ni, Pt—Ru—Ir—Y, Pt—Co—Mn, Pt—Co—Ni, Pt—Co—Fe, Pt—Co—Ir, Pt—Co—S, Pt—Co—P, Pt—Fe, Pt—Fe—Ir, Pt—Fe—S, Pt—Fe—P, Pt—Au—Co, Pt—Au—Fe, Pt—Au—Ni, Pt—Ni, Pt—Ni—Ir, Pt—Cr, and Pt—Cr—Ir. The metal catalyst supported inside the pores of the porous carrier and the metal catalyst existing outside the pores may be the same, but they do not necessarily have to be the same and may be different. The metal catalyst may be configured as a single type of catalyst or may be configured in a form including different types of metal catalyst particles.

According to an aspect of the present disclosure, there is provided a preparation method for a fuel cell catalyst, the preparation method including the steps of: (a) infiltrating a metal catalyst precursor or a metal catalyst seed into pores in a porous carrier; (b) producing metal catalyst particles by reducing the metal catalyst precursor or the metal catalyst seed; (c) removing metal catalyst particles present outside the pores of the porous carrier or metal catalyst particles bound with weak binding force inside the pores of the porous carrier; and (d) reducing and growing the metal catalyst particles by adding an additional metal catalyst precursor and a reducing agent, thereby obtaining post-grown metal catalyst particles which are more stably supported.

In the step (a), the metal catalyst precursor or the metal catalyst seed may include a metal selected from the group consisting of platinum and a platinum-based alloy.

Specifically, the platinum and the platinum-based alloy may be selected from the group consisting of Pt, Pt—Ru, Pt—Ir, Pt—Pd, Pt—Mn, Pt—Sn, Pt—Mo, Pt—Cr, Pt—W, Pt—Ni, Pt—Co, Pt—Y, Pt—Ru—W, Pt—Ru—Ir, Pt—Ru—Ni, Pt—Ru—Mo, Pt—Ru—Rh—Ni, Pt—Ru—Sn—W, Pt—Ru—Ir—Ni, Pt—Ru—Ir—Y, Pt—Co—Mn, Pt—Co—Ni, Pt—Co—Fe, Pt—Co—Ir, Pt—Co—S, Pt—Co—P, Pt—Fe, Pt—Fe—Ir, Pt—Fe—S, Pt—Fe—P, Pt—Au—Co, Pt—Au—Fe, Pt—Au—Ni, Pt—Ni, Pt—Ni—Ir, Pt—Cr, and Pt—Cr—Ir.

The metal catalyst precursor may include the metal particle elements included in the catalyst.

The metal catalyst seed may be in the form of a metal catalyst precursor partially reduced by reacting with a weak reducing agent, or may be in the form of a hydrated metal ligand. Additionally, the seed may include a single metal, but may also be configured in a form including two or more types of metals.

The method of forming the metal catalyst seed is to form a seed by partially reducing or hydrating a metal catalyst precursor in a metal catalyst precursor solution under mild conditions. As additives used to form the seed, weak reducing agents such as formaldehyde, formic acid, citric acid, and ascorbic acid may be used in a diluted state, and urea and hexamethylenetetramine may be used. More specifically, the method may be performed by mixing at least one additive selected from the group consisting of formaldehyde, formic acid, citric acid, ascorbic acid, urea, and hexamethylenetetramine with a metal catalyst precursor to prepare a metal catalyst precursor solution and heating the prepared solution.

Specifically, when using the urea or hexamethylenetetramine, the heating may be performed at a temperature of 80° C. to 110° C. for 0.5 to 3 hours. When the heating is performed at a temperature lower than the above range, the metal catalyst seed may not be sufficiently formed, whereas when it is performed at a temperature higher than the above range, the metal catalyst seed may grow excessively large. When the heating is performed for a shorter period of time than the above range, the metal catalyst seed may not be sufficiently formed, whereas when it is performed for a longer period of time than the above range, the metal catalyst seed may grow excessively large.

The metal catalyst precursor or the metal catalyst seed used to form the metal catalyst precursor may be a salt of platinum or a platinum-based alloy, specifically, a halide, a nitride, a potassium salt, a sodium salt, or the like of platinum or a platinum-based alloy, and may be, for example, selected from the group consisting of chloroplatinic acid (H₂PtCl₆), platinum(II) acetylacetonate (Pt(acac)₂), potassium tetrachloroplatinate (K₂PtCl₄), hydrogen hexachloroplatinate (H₂PtCl₄), platinum(II) cyanide (Pt(CN)₂), platinum(II) chloride (PtCl₂), platinum(II) bromide (PtBr₂), K₂PtCl₆, Pt(NH₃)₂(NO₂), Na₂PtCl₆, and a combination thereof. The metal catalyst precursor may be the same as or different from a metal catalyst precursor used in the step (d), which will be described later.

In the step (a), the material that infiltrates into the pores of the porous carrier is a metal catalyst precursor or a metal catalyst seed in a dissolved state, and the metal catalyst seed may have a size of 90% of the pore size of the porous carrier or smaller. For example, when the pore size of the porous carrier is 10 nm, the size of the seed may be equal to or less than 9 nm, equal to or less than 7 nm, or equal to or less than 3 nm. Preferably, the seed may have a size 1 to 3 nm in diameter. By setting the size of the metal catalyst seed within the above range, the seed is stably supported inside the pores of the carrier.

The infiltrating of the metal catalyst precursor or seed into the pores in the carrier in the step (a) may be performed by (i) using vacuum infiltration, (ii) using a solvent with good wettability, or (iii) separately hydrophilically-pretreating the pores of the carrier prior to the step (a). Alternatively, the method may be performed by combining the steps (i) to (iii).

In particular, the step (i) is a process for facilitating the infiltration of the metal catalyst precursor or the metal catalyst seed into the pores of the carrier. Specifically, when the vacuum infiltration method is used, it may be performed for 5 to 30 minutes under conditions of pressure of 0.01 to 90 kPa. By performing the vacuum infiltration within the above pressure range, the metal catalyst precursor or the metal catalyst seed is infiltrated into the pores of the carrier. Additionally, by performing the vacuum infiltration within the above time range, the effect of infiltrating the metal catalyst precursor or the metal catalyst seed into the pores using a practical vacuum infiltration method is sufficiently achieved.

Alternatively, the step (a) may enhance the infiltration ability of the metal catalyst precursor or the metal catalyst seed by (ii) utilizing a solvent with good wettability or (iii) separately hydrophilically modifying an inner surface of the carrier pores.

As the metal catalyst precursor or the metal catalyst seed is contained in a solution containing a solvent having good wettability, the infiltration ability of the solution is improved, and thus making it easy to prepare metal catalyst particles through the infiltration of the metal catalyst precursor or the metal catalyst seed into the pores. As the solvent with good wettability, a hydrophilic solvent such as an alcohol-based solvent may be used. The alcohol solvent may be an alcohol having 1 to 6 carbon atoms. Specifically, it may include at least one alcohol including a chain alcohol, a branched alcohol, etc. having 2 to 4 carbon atoms. The hydrophilic solvent may include, for example, at least one selected from the group consisting of isopropyl alcohol, ethanol, butyl alcohol, n-propyl alcohol, acetone, and formic acid.

When hydrophilically modifying the inner surface of the pores of the carrier, the surface may be treated in various ways without particular limitation and any treatment method is possible as long as it allows the surface to have hydrophilicity. The treatment method may include, for example, surface plasma treatment, hydrophilic functional group modification treatment, etc. Specifically, it may include a method of performing surface modification with a hydrophilic functional group. In this case, there is an advantage of modifying even the deep inner surface of the pores by immersing the carrier in a reactive solution for hydrophilic modification.

The hydrophilic functional group may be used without particular limitation as long as it is a hydrophilic functional group such as a hydroxyl group, a carboxylic acid group, an amine group, or a sulfonic acid group. Additionally, the hydrophilic functional group may not only correspond to a case modified with one type of hydrophilic functional group, but also correspond to a case modified with different types of hydrophilic functional groups.

In this way, a metal catalyst precursor or metal catalyst seed solution containing an alcohol-based solvent is immersed in the carrier in which the inner surface of the pores has been modified with a hydrophilic functional group, and the metal catalyst precursor or the metal catalyst seed is supported inside the pores in a state in which the infiltration rate of the solution into the pores of the carrier is improved.

The step (b) of producing of the metal catalyst particles by reducing the metal catalyst precursor or the metal catalyst seed may be performed by reducing the metal catalyst precursor or the metal catalyst seed using a reducing agent for metal catalysts in a state in which the metal catalyst precursor or the metal catalyst seed has infiltrated into the pores of the carrier.

The reducing agent utilized to produce the metal catalyst particles may be at least one reducing agent selected from the group consisting of NaBH₄, hydrazine, e-beam, LiAlH₄, diborane, ethylenediamine, formaldehyde, formic acid, citric acid, ascorbic acid, urea, glycols such as ethylene glycol, polyols having three or more —OH groups, and hexamethylenetetramine. The reducing in the step (b) may be performed by adding the reducing agent, followed by stirring or heating.

The step (c) may be performed by removing metal catalyst particles outside the carrier pores or metal catalyst particles with weak binding force and selecting only metal catalyst particles with strong binding force, thereby improving durability.

The removing of the metal catalyst particles outside the pores of the carrier or the metal catalyst particles with weak binding force may be performed by a physical method, such as ultrasonication or centrifugation.

The ultrasonication may be performed by applying ultrasonic waves to a catalyst supported with the metal catalyst particles in a mixed solution or in a solvent-redispersed solution at an intensity of equal to or greater than 20 kHz, with an amplitude of 30 to 90%, preferably 40% to 80%, for 5 to 80 minutes, preferably 10 to 60 minutes. When the ultrasonication is performed with an amplitude of less than 30%, the metal catalyst particles outside the carrier pores or those with weak binding force may not be effectively removed, whereas when it is performed with an amplitude exceeding 90%, some of the metal catalyst particles inside the carrier pores may also detach or aggregate. When the ultrasonication is performed for less than 5 minutes, the metal catalyst particles outside the carrier pores or with weak binding force may not be effectively removed, whereas when it is performed for more than 80 minutes, the catalyst inside the carrier and the pores may be damaged.

Additionally, the centrifugation may be performed at a speed of 13,000 to 35,000 rpm, preferably 15,000 to 30,000 rpm, for 10 to 100 minutes, preferably 20 to 80 minutes. When the centrifugation is performed at a speed less than 13,000 rpm, the metal catalyst particles outside the carrier pores or those with weak binding force may not be effectively removed, whereas when it is performed at a detached metal catalyst speed exceeding 35,000 rpm, particles may settle down and the aggregate. When centrifugation is performed for less than 10 minutes, the metal catalyst particles outside the carrier pores or those with weak binding force may not be effectively removed, whereas when it is performed for more than 100 minutes, detached metal catalyst particles may settle down and aggregate.

The mixed solution may refer to directly using a catalyst solution in which reduction has been completed. The solvent-redispersed solution may be a catalyst solution in which reduction has been completed, which is then filtered and redispersed in a solvent. As the solvent, alcohol or water may be used. The catalyst in the solution may have a concentration within 10%. By removing the metal catalyst particles outside the carrier pores or those with weak binding force through the ultrasonication or centrifugation, the durability of the catalyst is improved.

Additional reducing and growing in the step (d) may be performed by additionally adding a precursor of a metal catalyst and a reducing agent to the catalyst in which the metal catalyst precursor or the metal catalyst seed has been reduced in a state of having been infiltrated into the pores of the carrier in the step (b) to form the metal catalyst particles inside the pores of the carrier and then the metal catalyst particles outside the pores of the carrier or those with weak binding force have been removed.

A metal included in the metal catalyst precursor of the step (d) may be the same as or different from the metal included in the metal catalyst seed of the step (a).

In the step (d), the metal catalyst precursor may be a precursor of a metal catalyst selected from the group consisting of platinum and a platinum-based alloy. Specifically, the metal catalyst precursor may be a salt of the metal catalyst, for example, a salt of a metal catalyst selected from the group consisting of platinum and a platinum-based alloy. Here, specific examples of the platinum, the platinum-based alloy, and the salt thereof are referenced to those described in the step (a) above.

The additional metal catalyst precursor may be a solution in which a metal exists in an ionic state. The additional metal catalyst precursor may be added in an amount of 10 to 40 wt %, preferably 15 to 35 wt %, for example 23 wt %, with respect to the weight of the metal catalyst particles supported on the carrier. When the amount of the metal catalyst precursor is less than 10 wt %, the metal catalyst may not grow sufficiently to stably exist inside the pores, whereas when the amount exceeds 40 wt %, the metal catalyst particles with weak binding force may regrow outside the carrier, resulting in reduced durability.

The reducing agent may be at least one selected from the group consisting of relatively weak reducing agents such as formaldehyde, formic acid, citric acid, ascorbic acid, hexamethylenetetramine, ethylene glycol, tetraethylene glycol, and urea.

The reducing agent may be added at an equivalent ratio of 10 to 100 per mole of the additional metal catalyst precursor. When the reducing agent is added at a ratio lower than the above equivalent ratio, the metal catalyst precursor may not be sufficiently reduced, which may inhibit the growth of the metal catalyst particles, resulting in reduced durability and deteriorated performance. Whereas, when the reducing agent is added at a ratio higher than the above equivalent ratio, sufficient structure formation may not be achieved, which results in no noticeable difference in the properties of the prepared catalyst compared to the amount added. Therefore, from the viewpoint of preparation efficiency, it is preferable to add it at a ratio lower than the above equivalent ratio.

Additionally, a surfactant or organic acid may be additionally added in the step (d) to induce further growth of the metal catalyst particles.

The surfactant may be at least one surfactant selected from the group consisting of (C10-C18 alkyl) trimethylammonium salt-based cationic surfactants such as cetyltrimethylammonium bromide (CTAB); (C10-C18 alkyl) sulfite salt-based anionic surfactants such as sodium dodecylsulfate (SDS); and (C10-C18 alkyl) poly(ethylene oxide)-based nonionic surfactants such as Brij56 (polyoxyethylene cetyl ether). The organic acid may be a carboxylic acid such as lactic acid or oxalic acid.

The surfactant or the organic acid may be added in an amount of 5 to 25 wt %, preferably 7 to 20 wt %, with respect to the total weight of the solution of the step (d) containing the same. When the amount of the surfactant or the organic acid is less than 5 wt %, it may not be sufficient to help the metal catalyst particles grow, whereas when the amount exceeds 20 wt %, it may hinder the reduction and growth of the catalyst.

The reducing and growing in the step (d) may be performed at a temperature of 80° C. to 150° C. for 30 to 100 minutes. When the temperature is lower than 80° C. or the treatment time is shorter than 30 minutes, sufficient reduction and growth may not be achieved, whereas when the temperature exceeds 150° C. or the treatment time exceeds 100 minutes, excessive growth may occur, resulting in reduced performance and durability.

The fuel cell catalyst according to the present disclosure is prepared from a catalyst slurry prepared by mixing an ionomer and a dispersion medium used in an ion conductor dispersion, and the prepared catalyst slurry may be used to form an anode and/or a cathode of a membrane electrode assembly.

The membrane electrode assembly according to the present disclosure may be manufactured by forming a catalyst layer on a surface of a release film with the catalyst slurry and then transferring the catalyst layer onto a polymer electrolyte membrane by applying heat and pressure in a state in which the catalyst layer is in contact with the polymer electrolyte membrane, or coating the catalyst slurry directly on the polymer electrolyte membrane to form an electrode.

The membrane electrode assembly includes an anode, a cathode, and a polymer electrolyte membrane interposed therebetween, and at least one of the anode and the cathode includes the fuel cell catalyst according to the present disclosure.

The ionomer, which is mixed with the fuel cell catalyst to form a catalyst slurry, is used to transfer hydrogen ions and may also function as a binder for improving adhesion between the electrodes and the polymer electrolyte membrane. The ionomer may be a cation conductor having at least one proton exchange group selected from the group consisting of a sulfonic acid group, a carboxyl group, a boronic acid group, a phosphoric acid group, an imide group, a sulfonimide group, a sulfonamide group, a sulfonic acid fluoride group, and a combination thereof.

Specifically, the ionomer according to an embodiment of the present disclosure may be a fluorine-based cation conductor having a sulfonic acid group and/or a carboxyl group, a hydrocarbon-based cation conductor having a sulfonic acid group and/or a carboxyl group, or a mixture thereof.

It is preferable that the content of the catalyst in the catalyst slurry is adjusted so that the weight of the catalyst is 20 to 80 wt % with respect to the total weight of the electrode. When the content of the catalyst in the electrode is less than 20 wt %, the catalytic activity required for the electrode may not be satisfied. Whereas, when the content of the catalyst in the electrode exceeds 80 wt %, the catalytic activity may be rather reduced as the active area of the catalyst decreases due to agglomeration of the catalysts.

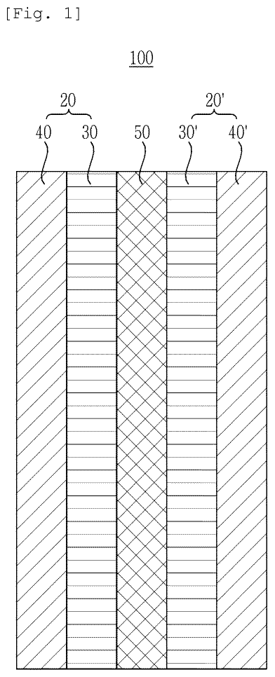

FIG. 1 is a sectional view schematically illustrating a membrane electrode assembly according to the present disclosure. Referring to FIG. 1, the membrane electrode assembly 100 includes a polymer electrolyte membrane 50 and electrodes 20, 20′ disposed on opposite surfaces of the polymer electrolyte membrane 50, respectively. The electrode 20, 20′ includes an electrode substrate 40, 40′ and a catalyst layer 30, 30′ formed on a surface of the electrode substrate 40, 40′, and may further include a microporous layer (not illustrated) containing conductive fine particles such as carbon powder or carbon black between the electrode substrate 40, 40′ and the catalyst layer 30, 30′ to facilitate mass diffusion at the electrode substrate 40, 40′.

In the membrane electrode assembly 100, the electrode 20, which is disposed on a first surface of the ion exchange membrane 50 and causes an oxidation reaction to generate hydrogen ions and electrons from fuel transferred to the catalyst layer 30 through the electrode substrate 40, is referred to as an anode electrode, and the electrode 20′, which is disposed on a second surface of the ion exchange membrane 50 and causes a reduction reaction to generate water from the hydrogen ions supplied through the ion exchange membrane 50 and an oxidizing agent transferred to the catalyst layer 30′ through the electrode substrate 40′, is referred to as a cathode electrode.

As the electrode substrate 40, 40′, a porous conductive substrate may be used to ensure smooth supply of hydrogen or oxygen. Representative examples thereof include, but are not limited to, carbon paper, carbon cloth, carbon felt, or metal cloth (a porous film made of fibrous metal cloth or a metal film formed on a surface of cloth made of polymer fibers). Additionally, it is preferable that the electrode substrates 40, 40′ is water-repellent treated with a fluorine-based resin to prevent reactant diffusion efficiency from being reduced by water generated during the operation of the fuel cell.

As the fluorine-based resin, polytetrafluoroethylene, polyvinylidene fluoride, polyhexafluoropropylene, polyperfluoroalkyl vinyl ether, polyperfluorosulfonylfluoride alkoxy vinyl ether, fluorinated ethylene propylene, polychlorotrifluoroethylene, or a copolymer thereof may be used.

A fuel cell according to an embodiment of the present disclosure may be, for example, a fuel cell that includes the membrane electrode assembly and uses hydrogen gas as fuel.

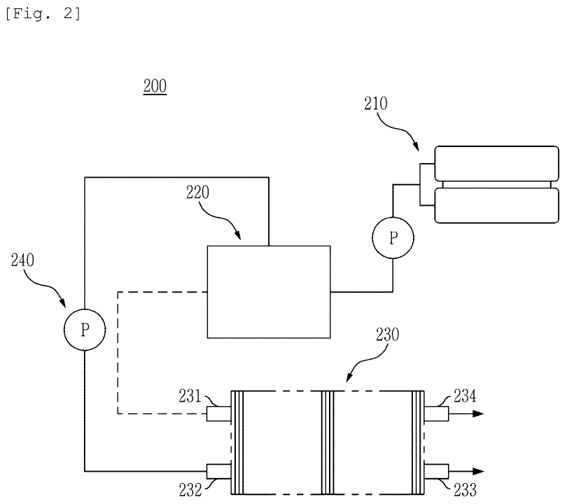

FIG. 2 is a schematic view illustrating the overall configuration of a fuel cell according to an embodiment of the present disclosure.

Referring to FIG. 2, the fuel cell 200 includes a fuel supply unit 210 that supplies a mixed fuel in which fuel and water are mixed, a reforming unit 220 that reforms the mixed fuel to generate a reformed gas containing hydrogen gas, a stack 230 that generates electrical energy by causing an electrochemical reaction between the hydrogen gas-containing reformed gas supplied from the reforming unit 220 and an oxidizing agent, and an oxidizing agent supply unit 240 that supplies the oxidizing agent to the reforming unit 220 and the stack 230.

The stack 230 includes a plurality of unit cells that generate electrical energy by inducing an oxidation/reduction reaction between the hydrogen gas-containing reformed gas supplied from the reforming unit 220 and the oxidizing agent supplied from the oxidizing agent supply unit 240.

Each of the unit cells refers to a unit cell that generates electricity, and includes the membrane electrode assembly that oxidizes/reduces the hydrogen gas-containing reformed gas and oxygen in the oxidizing agent, and separators (also referred to as bipolar plates, hereinafter referred to as “separators”) that supply the hydrogen gas-containing reformed gas and the oxidizing agent to the membrane electrode assembly. The separators are disposed on opposite sides of the membrane electrode assembly. At this time, the separators located at the outermost sides of the stack may be particularly referred to as end plates.

Among the separators, one of the end plates is provided with a pipe-shaped first supply tube 231 for injecting the hydrogen gas-containing reformed gas supplied from the reforming unit 220 and a pipe-shaped second supply tube 232 for injecting oxygen gas, and the remaining end plate is provided with a first discharge tube 233 for discharging the hydrogen gas-containing reformed gas that finally remains unreacted in the plurality of unit cells to the outside and a second discharge tube 234 for discharging the oxidizing agent that finally remains unreacted in the unit cells to the outside.

### MODE FOR INVENTION

Hereinafter, the present disclosure will be described in more detail with respect to Examples thereof. However, this is merely exemplary description for understanding the present disclosure, and the scope of the present disclosure is not limited or restricted to the following Examples.

### Example 1

0.4 g of H₂PtCl₆ as a metal catalyst precursor was added to a solution in which 4 g of ethylene glycol was dissolved in water, and mixed uniformly. 0.2 g of a porous carbon carrier (specific surface area 750 to 850 m²/g, maximum pore size 4.9 nm) was added to the solution and dispersed uniformly.

The solution was placed in a simple vacuum adsorption device and treated under a vacuum of 10 kPa for 20 minutes to adsorb the Pt catalyst precursor-reducing agent mixed solution into pores of the carbon carrier.

A small amount of ammonia or sodium hydroxide aqueous solution was added to the solution to adjust pH to equal to or higher than 9, after which the solution was heated under reflux at 130° C. for 2 hours to reduce the Pt catalyst precursor, and thus Pt metal catalyst particles were produced.

The reduced solution was treated for 50 minutes at an amplitude (Amp.) of 50% using a 20 kHz ultrasonic disperser to remove metal catalyst particles outside the carrier pores or those with weak binding force, followed by filtering and drying to prepare a catalyst.

After redispersing the catalyst thus prepared in water, 2 g of ethylene glycol or 1 g of hexamethylenetetramine and 0.15 g of H₂PtCl₆ as a metal catalyst precursor were added thereto and mixed uniformly. The mixture was heated under reflux at 130° C. for 1 hour to reduce and grow the Pt catalyst precursor, followed by filtering and drying. Thus, a more stable post-grown catalyst was prepared.

### Example 2

A catalyst was prepared in the same manner as in Example 1 above, except that when preparing a post-grown catalyst (i.e., performing step (d)), 0.01 g of CTAB was additionally added to a mixed solution and washing with a 0.1 M hydrochloric acid solution was performed during filtering to remove CTAB.

### Example 3

A catalyst was prepared in the same manner as in Example 1 above, except that a reducing agent and a precursor were dissolved in a mixed solution of water and ethanol (2:8), a carrier after plasma treatment was added and infiltrated, and vacuum infiltration was not performed. Compared to Example 1, larger metal catalyst particles were obtained.

### Example 4

0.4 g of H₂PtCl₆ as metal catalyst precursor was added to a solution in which 2 g of hexamethylenetetramine was dissolved in water, and mixed uniformly. A catalyst was prepared in the same manner as Example 1, except that the solution was heated at 100° C. for 1 hour to form a metal catalyst seed having an average size of 1.8 nm.

### [Comparative Example 1] Conventional Preparation Method

According to a conventional catalyst preparation method, H₂PtCl₆ as a metal catalyst precursor and a porous carbon carrier were dispersed in a solvent. The solution was reduced with NaBH₄, and thus a catalyst was prepared.

### [Comparative Example 2] Not Performing Steps (c) and (d) of the Present Disclosure

Porous carbon was pretreated with distilled water through a pretreatment method, and H₂PtCl₆ as a metal catalyst precursor was added thereto. The resulting product was subjected to additional vacuum treatment (10 kPa, 60 minutes) and reduced to prepare a catalyst.

### Manufacturing Example

Membrane electrode assemblies were all manufactured in the same manner, except that catalysts prepared by Examples and Comparative Examples above were utilized respectively.

### [Evaluation Example 1] Distribution and Size of Metal Catalyst Particles Inside and Outside Carrier Pores

The distribution and size of metal catalyst particles inside and outside carrier pores were measured for catalysts prepared by Comparative Examples 1 and 2 and Examples 1, 2 and 3, and the results are illustrated in Table 1 below.

TABLE 1
Comparison of distribution and size of metal catalyst
particles inside and outside carrier pores

| | Metal catalyst | | Metal catalyst | | |
|---|---|---|---|---|---|
| | particles inside | | particles outside | | |
| | pores | | pores | | Carrier |
| | | Size | | Size | pore size |
| | Ratio¹⁾ | (nm_{—} | Ratio²⁾ | (nm_{—} | (nm_{—} |
| Sample | (%, M1) | mode) | (%, M2) | mode) | mode) |
| Comparative | 15 | 2.7 | 85 | 2.7 | 4.9 |
| Example 1 | | | | | |
| Comparative | 72 | 2.9 | 28 | 3.1 | 4.9 |
| Example 2 | | | | | |
| Example 1 | 86 | 5.0 | 14 | 6.5 | 4.9 |
| Example 2 | 84 | 5.1 | 16 | 6.9 | 4.9 |
| Example 3 | 75 | 5.5 | 25 | 11.3 | 4.9 |
| Example 4 | 85 | 5.2 | 15 | 6.9 | 4.9 |

¹⁾, ²⁾with respect to the total number of metal catalyst particles supported on a porous carrier

As can be seen from Table 1 above, the catalysts of Examples 1, 2 and 4 according to the present disclosure were supported in the pores of the porous carrier in an amount of equal to or greater than 80% with respect to the total number of supported metal catalyst particles, and the catalyst of Example 3 was supported in an amount of equal to or greater than 74%. Additionally, it can be seen that in the case of the catalysts of Examples 1 and 2 according to the present disclosure, the size of the metal catalyst particles supported in the pores of the porous carrier increased within a range of +5% with respect to the pore size of the porous carrier, and in the case of Examples 3 and 4, the size of the metal catalyst particles increased within a range of +15%.

### [Evaluation Example 2] Observation of Particle Shape, Distribution, and Size Via TEM Analysis

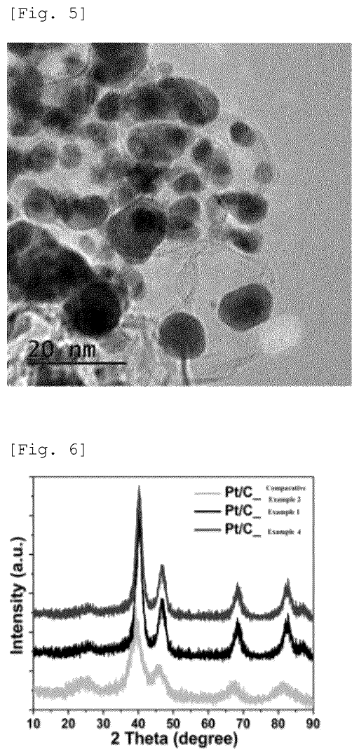

TEM analysis was performed to analyze the particle shape, distribution, and size of catalysts prepared by Examples 1 to 3, and the results are illustrated in FIGS. 3 to 5, respectively. As can be seen from FIGS. 3 to 5, catalyst particles were mainly formed in a spherical or oval shape, and in the case of the catalyst particles of Example 2 in FIG. 4, some rod-shaped particles were also observed.

### [Evaluation Example 3] XRD Analysis

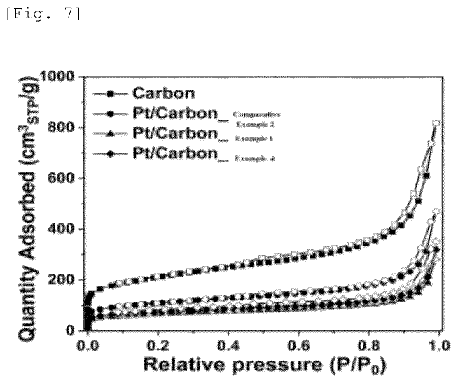

To determine the particle size and crystallinity of catalysts prepared by Comparative Example 2 and Examples 1 and 4, XRD was analyzed and the results are illustrated in FIG. 6.

According to the results in FIG. 6, it can be seen that the catalysts prepared by Examples 1 and 4 had larger particle sizes and higher crystallinity.

### [Evaluation Example 4] BET Analysis

To determine the specific surface area and pore volume of catalysts prepared by Comparative Example 2 and Examples 1 and 4, BET was analyzed and the results are illustrated in FIG. 7.

According to the results in FIG. 7, it can be seen that the specific surface area and micropore volume of the catalysts prepared by Examples 1 and 4 were small, indicating that metal catalyst particles filled pores.

Additionally, the results of analyzing the specific surface area before and after preparation of the catalysts of Comparative Example 2 and Examples 1 and 4 are illustrated in Table 2 below.

TABLE 2
Specific surface area analysis results
before/after catalyst preparation

Specific surface area (m²/g)

| Sample | Before preparation | After preparation |
|---|---|---|
| Comparative | 810 | 360 |
| Example 2 | | |
| Example 1 | 810 | 260 |
| Example 4 | 810 | 270 |

As can be seen from Table 2 above, the catalysts of Examples 1 and 4 according to the present disclosure had surface areas reduced by about 68% and 67%, respectively, with respect to the surface area of an untreated porous carrier (before catalyst preparation), whereas the catalyst of Comparative Example 2 showed a surface area reduction of about 55%.

### [Evaluation Example 5] Catalyst Durability Evaluation

A DOE catalyst durability evaluation experiment was conducted on catalysts of Comparative Example 1, Comparative Example 2, Example 1, Example 2, and Example 4, and the results are illustrated in [Table 3].

TABLE 3
Catalyst durability evaluation results
(voltage loss after DOE 10,000 cycles)

| | Comparative | Comparative | | | |
|---|---|---|---|---|---|
| Sample | Example 1 | Example 2 | Example 1 | Example 2 | Example 4 |
| Voltage | 42.5 mV | 25.8 mV | 10.6 mV | 11.2 mV | 10.6 mV |
| loss | | | | | |

As can be seen from [Table 3], the catalysts of Comparative Examples 1 and 2 showed a larger voltage loss than the catalyst of Examples according to the present disclosure after DOE 10,000 cycles.

1. A fuel cell catalyst, comprising:
a porous carrier; and
a metal catalyst supported on the porous carrier,
wherein the metal catalyst is supported in pores of the porous carrier in an amount of equal to or greater than 74% with respect to the total number of metal catalyst particles supported on the porous carrier.

2. The fuel cell catalyst of claim 1, wherein the metal catalyst is supported in the pores of the porous carrier in an amount of equal to or greater than 80% with respect to the total number of the metal catalyst particles supported on the porous carrier.

3. The fuel cell catalyst of claim 1, wherein each of the metal catalyst particles supported in the pores of the porous carrier has a size of −15% to +15% with respect to a pore size of the porous carrier.

4. The fuel cell catalyst of claim 3, wherein each of the metal catalyst particles supported in the pores of the porous carrier has a size of −5% to +5% with respect to the pore size of the porous carrier.

5. The fuel cell catalyst of claim 1, wherein the metal catalyst is supported in the pores of the porous carrier by filling equal to or greater than 60% of the pores with respect to the total pore volume.

6. The fuel cell catalyst of claim 1, wherein the fuel cell catalyst has a specific surface area of equal to or less than 300 m²/g.

7. The fuel cell catalyst of claim 1, wherein the porous carrier has a pore size of 2 to 15 nm.

8. The fuel cell catalyst of claim 1, wherein the metal catalyst has a diameter of 3 to 14 nm.

9. The fuel cell catalyst of claim 1, wherein the metal catalyst inside the pores of the porous carrier has a diameter that is at least 1 nm smaller than that of the metal catalyst outside the pores.

10. A preparation method for a fuel cell catalyst, the preparation method comprising the steps of:
(a) infiltrating a metal catalyst precursor or a metal catalyst seed into pores in a porous carrier;
(b) producing metal catalyst particles by reducing the metal catalyst precursor or the metal catalyst seed;
(c) removing metal catalyst particles present outside the pores of the porous carrier or metal catalyst particles bound with weak binding force inside the pores of the porous carrier; and
(d) reducing and growing the metal catalyst particles by adding an additional metal catalyst precursor and a reducing agent, thereby obtaining a metal catalyst.

11. The preparation method of claim 10, wherein the step (a) is performed by vacuum infiltration.

12. The preparation method of claim 11, wherein the vacuum infiltration is performed for 5 to 30 minutes under conditions of pressure of 0.01 to 90 kPa.

13. The preparation method of claim 10, wherein the metal catalyst precursor or the metal catalyst seed of the step (a) includes a metal selected from the group consisting of platinum and a platinum-based alloy.

14. The preparation method of claim 10, further comprising the step of:
(aa) preparing a metal catalyst seed by partially reducing or hydrating a metal catalyst precursor prior to the step (a).

15. The preparation method of claim 14, wherein the step (aa) is performed by mixing and heating the metal catalyst precursor and at least one additive selected from the group consisting of formaldehyde, formic acid, citric acid, ascorbic acid, urea, and hexamethylenetetramine.

16. The preparation method of claim 10, wherein the step (b) is performed by adding at least one additive selected from the group consisting of NaBH₄, hydrazine, e-beam, LiAlH₄, diborane, ethylenediamine, formaldehyde, formic acid, citric acid, ascorbic acid, urea, glycols such as ethylene glycol, polyols having three or more-OH groups, and hexamethylenetetramine to the metal catalyst precursor or the metal catalyst seed, followed by stirring or heating.

17. The preparation method of claim 10, wherein the step (c) is performed by ultrasonication or centrifugation.

18. The preparation method of claim 17, wherein the ultrasonication is performed by applying ultrasonic waves for 5 to 80 minutes at an intensity of equal to or greater than 20 kHz and an amplitude of 30% to 90%.

19. The preparation method of claim 17, wherein the centrifugation is performed at 13,000 to 35,000 rpm for 10 to 100 minutes.

20. The preparation method of claim 10, wherein the additional metal catalyst precursor of the step (d) includes a metal the same as or different from a metal contained in the metal catalyst seed of the step (a), and the metal is selected from the group consisting of platinum and a platinum-based alloy.

21. The preparation method of claim 10, wherein the additional metal catalyst precursor of the step (d) is added in an amount of 10 to 40 wt % with respect to a weight of the metal catalyst particles supported on the carrier.

22. The preparation method of claim 10, wherein the reducing agent of the step (d) is at least one selected from the group consisting of formaldehyde, formic acid, citric acid, ascorbic acid, hexamethylenetetramine, ethylene glycol, tetraethylene glycol, and urea.

23. The preparation method of claim 10, wherein the reducing agent of the step (d) is added at an equivalent ratio of 10 to 100 per mole of the additional metal catalyst precursor.

24. The preparation method of claim 10, wherein a surfactant, an organic acid, or both of them are additionally added in the step (d).

25. The preparation method of claim 24, wherein the surfactant is at least one surfactant selected from the group consisting of (C10-C18 alkyl) trimethylammonium salt-based cationic surfactants, (C10-C18 alkyl) sulfite salt-based anionic surfactants, and (C10-C18 alkyl) poly(ethylene oxide)-based nonionic surfactants, and
the organic acid is at least one organic acid selected from carboxylic acids.

26. The preparation method of claim 10, wherein the step (d) is performed at a temperature of 80° C. to 150° C. for 30 to 100 minutes.

27. A membrane electrode assembly, comprising:
the fuel cell catalyst of claim 1.

28. A fuel cell, comprising:
the membrane electrode assembly of claim 27.
